(19) United States
(12) Patent Application Publication
(10) Pub. No.: US 2025/0182384 A1
(43) Pub. Date: Jun. 5, 2025

(54) POSITIONING METHOD AND POSITIONING SYSTEM

(71) Applicant: SEIKO EPSON CORPORATION, Tokyo (JP)

(72) Inventors: Taisuke Yamauchi, Matsumoto-shi (JP); Akira Ikeda, Chino-shi (JP)

(73) Assignee: SEIKO EPSON CORPORATION, Tokyo (JP)

(21) Appl. No.: 18/964,143

(22) Filed: Nov. 29, 2024

(30) Foreign Application Priority Data
Nov. 30, 2023 (JP) 2023-203006

(51) Int. Cl. G06T 15/20

(52) U.S. Cl. CPC G06T 15/20

(57) ABSTRACT

A control device that controls a projector includes a virtual space manager, a calculator, and a projection controller. The virtual space manager places virtual objects corresponding to the projector, a load base object, and a load in a virtual space while maintaining a relative position relationship therebetween in the actual space. The calculator sets an axis parallel to a vertical axis in the virtual space as a guide axis when projecting a guide image for showing a loading position of the load by an orthogonal projection and calculates an orthogonal projection guide image corresponding to the guide image projected onto the virtual object corresponding to the load in the virtual space by orthogonal projection, based on the relative position relationship between the virtual objects. The projection controller controls the projector to project the orthogonal projection guide image onto the load.

The present application is based on, and claims priority from JP Application Serial Number 2023-203006, filed Nov. 30, 2023, the disclosure of which is hereby incorporated by reference herein in its entirety.

### BACKGROUND

### 1. Technical Field

The present disclosure relates to a positioning method and a positioning system.

### 2. Related Art

In an assembly step of a product or a building, there have been proposed various techniques for assisting positioning when loading a load on a load base object, by using a laser light source or a projector to display a marker on an upper surface of the load base object to show a position. For example, JP-A-2017-87559 discloses a positioning method of a load in which a marker video is projected from a projector to provide a nest on an inner surface of a lower mold at a predetermined position. The marker video includes a positioning line having a predetermined width. The nest is an example of a load, and the inner surface of the lower mold is an example of a load base object.

However, in the technique disclosed in JP-A-2017-87559, except for a case in which an arrangement position of the projector is vertically above the load and the load base object and an optical axis of a projection light from the projector is parallel to a vertical line of the load and the load base object, the projection is performed obliquely. Therefore, the marker is distorted and projected and is not displayed in an accurate position. For example, when the load is introduced in a state of being inclined from the horizontal direction when the load is introduced, the marker is not displayed at a desired position. Also when there is unevenness on an upper surface of the load, the marker is distorted and projected, and the accurate position cannot be shown. Further, since a projection video of the projector is projected by a perspective projection, the marker is displayed at a position shifted from the desired position due to an influence of the projection when the load is not directly placed on the load base object, and the accurate position cannot be shown.

### SUMMARY

An aspect of a positioning method of the present disclosure is a positioning method for positioning a second object to be loaded on a first object in a first direction of an actual space, and the positioning method includes: placing, in a virtual space, a first virtual object corresponding to the first object, a virtual projection device corresponding to a projection device configured to project a guide image for showing a loading position of the second object with respect to the first object onto at least one of the first object and the second object, and a virtual detection device corresponding to a detection device configured to detect at least the second object in the actual space, while maintaining a relative position relationship therebetween in the actual space, and placing a second virtual object corresponding to the second object in the virtual space according to a detection result by the detection device; setting an axis parallel to the first direction as a guide axis when orthogonally projecting the guide image, among three axes constituting a three-dimensional coordinate system associated with the first virtual object; generating an orthogonal projection guide image corresponding to the guide image projected from the virtual projection device onto the second virtual object by an orthogonal projection along the guide axis based on the relative position relationship between the virtual projection device and the second virtual object placed in the virtual space according to the detection result by the detection device; and controlling the projection device to project the orthogonal projection guide image onto the second object.

In addition, an aspect of a positioning system of the present disclosure is a positioning system for positioning a second object to be loaded on a first object in a first direction of an actual space, the positioning system includes: a projection device configured to project a guide image for showing a loading position of the second object with respect to the first object onto at least one of the first object and the second object; a detection device configured to detect at least the second object in the actual space; and one or more processors configured to: place, in a virtual space, a first virtual object corresponding to the first object, a virtual projection device corresponding to the projection device, and a virtual detection device corresponding to the detection device while maintaining a relative position relationship therebetween in the actual space, and place a second virtual object corresponding to the second object in the virtual space according to a detection result by the detection device; sets an axis parallel to the first direction as a guide axis when orthogonally projecting the guide image, among three axes constituting a three-dimensional coordinate system associated with the first virtual object, generate an orthogonal projection guide image corresponding to the guide image projected from the virtual projection device onto the second virtual object by an orthogonal projection along the guide axis, based on the relative position relationship between the virtual projection device and the second virtual object placed in the virtual space according to the detection result by the detection device, and control the projection device to project the orthogonal projection guide image onto the second object.

### BRIEF DESCRIPTION OF THE DRAWINGS

FIG. 1 is a diagram illustrating a configuration example of a positioning system according to a first embodiment of the present disclosure.

FIG. 2 is a diagram illustrating a guide image.

FIG. 3 is a diagram illustrating an example of a relative position relationship in an actual space between an actual space coordinate system, a projector coordinate system, and a camera coordinate system.

FIG. 4 is a diagram illustrating a relationship between a position on a captured image and a position in a camera coordinate.

FIG. 5 is a diagram illustrating a configuration example of a control device.

FIG. 6 is a diagram illustrating an orthogonal projection and a perspective projection.

FIG. 7 is a diagram illustrating an example of an orthogonal projection guide image projected onto a load base object.

FIG. 8 is a diagram illustrating an example of the orthogonal projection guide image projected onto a load.

FIG. 9 is a diagram illustrating another example of the orthogonal projection guide image projected onto the load.

FIG. 10 is a diagram illustrating another example of the orthogonal projection guide image projected onto the load.

FIG. 11 is a flowchart illustrating a flow of processing in a positioning method executed by a processing device according to a program.

### DESCRIPTION OF EMBODIMENTS

Various technically preferable limitations are attached to embodiments to be described later. However, the embodiments of the present disclosure are not limited to the forms to be described below.

### 1. First Embodiment

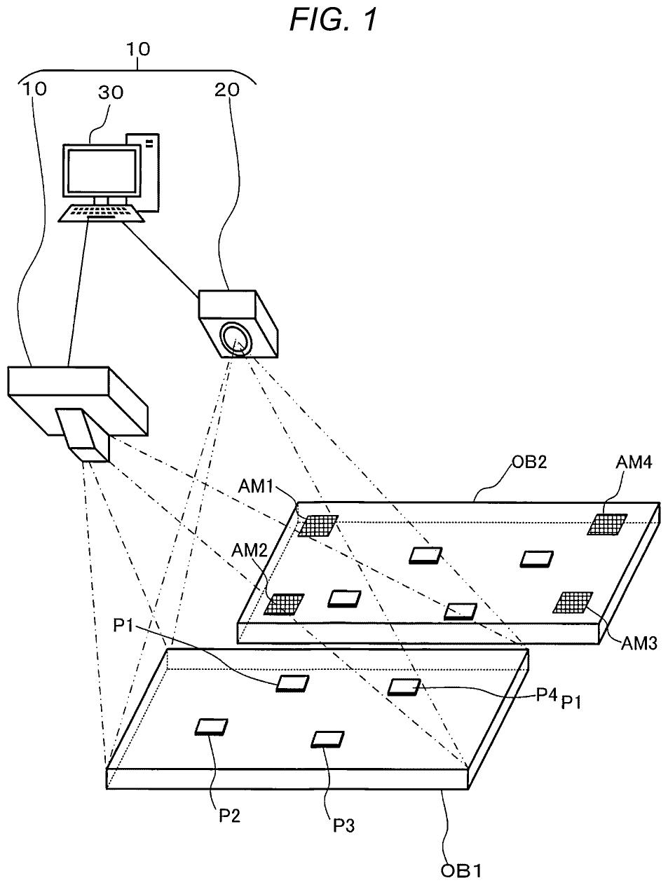

FIG. 1 is a diagram illustrating a configuration example of a positioning system 1 according to a first embodiment of the present disclosure. The positioning system 1 is a system for assisting in disposing a load OB2 on a load base object OB1 in a correct position in a step of assembling a product by loading the load OB2 on the load base object OB1 in a vertical direction. The vertical direction is an example of a loading direction in which the load OB2 is loaded onto the load base object OB1, and is, for example, a gravity direction in which gravity acts on the load base object OB1 and the load OB2. The load base object OB1 is a lower part of the product manufactured in the assembly step, and the load OB2 is an upper part of the product. A space in which the assembly step is executed is an example of an actual space in the present disclosure, and the vertical direction in the actual space is an example of a first direction in the present disclosure. The load base object OB1 is an example of a first object in the present disclosure, and the load OB2 is an example of a second object in the present disclosure.

As illustrated in FIG. 1, the load base object OB1 according to the embodiment is a part formed in a rectangular shape in a plan view and has protrusions P1 to P4 protruding from an upper surface thereof. In the assembly step in the embodiment, the load base object OB1 is fixed on, for example, a working table in a posture in which an upper surface is horizontal.

As illustrated in FIG. 1, the load OB2 is a part formed in a rectangular shape in a plan view similarly to the load base object OB1 and has four protrusions respectively corresponding to the protrusions P1 to P4 on an upper surface thereof. Four recesses respectively corresponding to the protrusions P1 to P4 are provided in a bottom surface of the load OB2. In FIG. 1, illustration of these four recesses is omitted. A worker in the assembly step lowers the load OB2 in the vertical direction with respect to the load base object OB1 while adjusting a position and a posture of the load OB2 with respect to the load base object OB1 such that the protrusions P1 to P4 correspond to the four recesses, respectively. That is, the protrusions P1 to P4 serve as a plurality of reference points at the time of positioning. In the embodiment, the number of reference points is four, and the number of reference points may be two, three, or five or more.

In the embodiment, as illustrated in FIG. 1, augmented reality (AR) markers AM1 to AM4 are provided in advance on the upper surface of the load OB2. AR is a technique for displaying various contents to be superimposed on the actual space. In general, the AR marker is used as information indicating a display position of the content in the actual space. As will be described in detail later, the AR markers AM1 to AM4 are used to detect the position and the posture of the load OB2 that change every moment in the assembly step.

In the related art, when the load OB2 is loaded on the load base object OB1, the worker needs to perform the positioning while checking a current position of the load OB2 with respect to the load base object OB1 each time, for example, by looking at a space between the load OB2 and the load base object OB1. Therefore, if the load OB2 is large, or if the load OB2 is heavy, a plurality of workers, for example, needs to work in unison while holding the load OB2, which is troublesome.

If positions of the plurality of reference points described above can be continuously displayed on the load OB2, the positioning becomes easy. For example, when a plurality of laser pointers are disposed vertically above the plurality of reference points, the positions of the plurality of reference points can be displayed on the load OB2. However, when any one of the plurality of reference points is changed, it is not possible to cope with the change. The positioning system 1 is a system that shows the plurality of reference points set in advance by using a projector 10 to the worker. As will be described in detail later, according to the embodiment, it is possible to show an accurate position of each of the plurality of reference points to the worker regardless of an arrangement position of the projector 10 and an orientation of an optical axis. As illustrated in FIG. 1, the positioning system 1 includes an imaging device 20 and a control device 30 in addition to the projector 10. The projector 10 and the imaging device 20 are connected to the control device 30 by wire or wirelessly.

The imaging device 20 is, for example, a video camera. The imaging device 20 includes an imaging lens (not illustrated) and an imaging element (not illustrated) on which a light from the imaging lens forms an image. The imaging element is, for example, a complementary metal-oxide-semiconductor (CMOS) sensor, and is not particularly limited. The imaging device 20 is disposed in the actual space at a position and a posture such that the entire upper surface of the load base object OB1 falls within an imaging field of view. In FIG. 1, an imaging range of the imaging device 20 is indicated by two-dot chain lines. An installation position of the imaging device 20 in the actual space is not limited to being vertically above the load base object OB1. An optical axis of the imaging lens of the imaging device 20 may not be parallel to a vertical axis. The imaging device 20 captures an image in the imaging field of view as needed and transmits image data representing the captured image to the control device 30. When the load OB2 is introduced into the imaging field of view of the imaging device 20, a position and a posture of the load OB2 in the actual space are estimated based on the markers AM1 to AM4 in the image captured by the imaging device 20. That is, the imaging device 20 serves as a detection device that detects the load OB2.

The projector 10 includes a display panel (not illustrated) and a projection lens for enlarging a display image displayed on the display panel and projecting the enlarged display image at least onto the load base object OB1. The display panel is, for example, a liquid crystal panel including a plurality of pixels for forming the display image, and is not particularly limited thereto. The projector 10 is disposed in the actual space in the position and the posture such that the entire upper surface of the load base object OB1 falls within a projection range. In FIG. 1, the projection range of the projector 10 is indicated by dash-dotted lines. An installation position of the projector 10 in the actual space is not limited to being vertically above the load base object OB1. An optical axis of the imaging lens of the projector 10 may not be parallel to the vertical axis. The projector 10 projects a guide image G1 for showing a loading position of the load OB2 with respect to the load base object OB1 to the worker under the control of the control device 30. The projector 10 is an example of a projection device in the present disclosure.

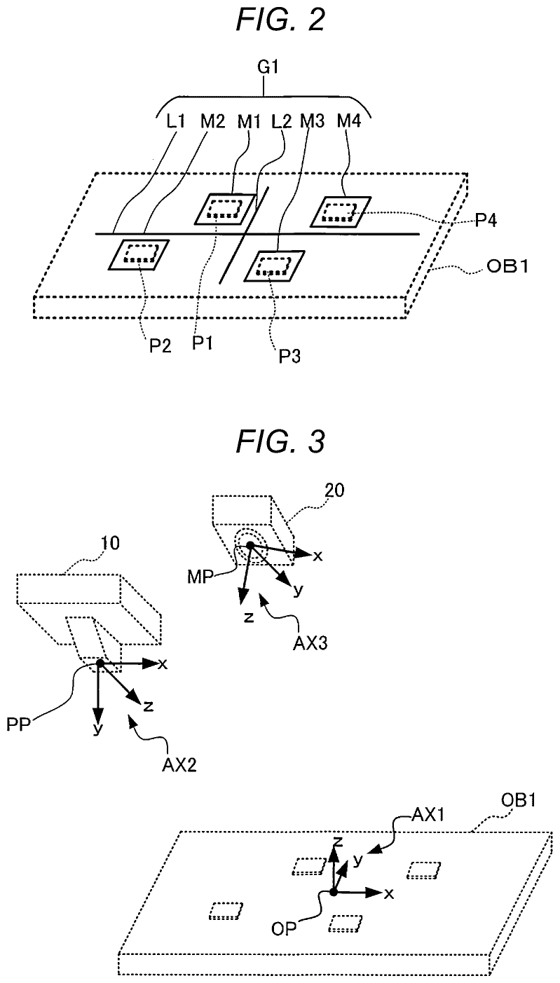

FIG. 2 is a diagram illustrating an example of the guide image G1. FIG. 2 illustrates a state in which the guide image G1 is projected onto the upper surface of the load base object OB1. When the worker introduces the load OB2 above the load base object OB1, the guide image G1 is projected onto the load OB2. As illustrated in FIG. 2, the guide image G1 includes markers M1 to M4 and guidelines L1 and L2. The markers M1 to M4 are disposed at positions corresponding to the protrusions P1 to P4 when the upper surface of the load base object OB1 is viewed vertically from above, and are rectangles slightly larger than upper surfaces of the protrusions P1 to P4, respectively. The markers M1 to M4 are used for showing, to the worker, positions of the reference points when the load OB2 is correctly loaded on the load base object OB1. The guideline L1 is a line segment along a long side of the rectangle described above, and the guideline L2 is a line segment along a short side of the rectangle described above. An intersection point of the guideline L1 and the guideline L2 corresponds to a center of the upper surface of the load base object OB1 when the upper surface is vertically viewed from above.

In the embodiment, parameters (so-called internal parameters) around the lenses of the projector 10 and the imaging device 20 and parameters (so-called external parameters) representing the relative positions and postures of the projector 10 and the imaging device 20 are calibrated in advance before the start of the assembly step and are known. The internal parameters and the external parameters are stored in advance in the control device 30. The external parameters include parameters for associating a projector coordinate system with an actual space coordinate system and parameters for associating a camera coordinate system with the actual space coordinate system. Details of the actual space coordinate system, the projector coordinate system, and the camera coordinate system are as follows.

FIG. 3 is a diagram illustrating the actual space coordinate system, the projector coordinate system, and the camera coordinate system. The actual space coordinate system is a three-dimensional coordinate system AX1 with a center OP of the upper surface of the load base object OB1 as an origin, the vertical direction as a z axis, a long side direction of the upper surface of the load base object OB1 as an x axis, and a short side direction of the upper surface of the load base object OB1 as a y axis. The upper surface of the load base object OB1 is a load base surface on which the load OB2 is loaded. The actual space coordinate system may be a local coordinate system of the load base object OB1. The projector coordinate system is a three-dimensional coordinate system AX2 with a principal point PP of the projection lens of the projector 10 as an origin, the optical axis of the projection lens as a z axis, a horizontal scanning direction of the projection image of the projector 10 as an x axis, and a vertical scanning direction of the same as a y axis. The projector coordinate system may be a local coordinate system of the projector 10. The camera coordinate system is a three-dimensional coordinate system AX3 with a principal point MP of the imaging lens of the imaging device 20 as an origin, the optical axis of the imaging lens as a z axis, a horizontal scanning direction of the projection image of the imaging device 20 as an x axis, and a vertical scanning direction of the same as a y axis. The camera coordinate system may be a local coordinate system of the imaging device 20.

Examples of a method of calibrating the external parameters include a method based on the principle of perspective n-points (PnP). For example, a method of calibrating the parameters for associating the camera coordinate system with the actual space coordinate system is as follows. A user or the control device 30 to be described later that executes the calibration method first causes the projector 10 to project a measurement image such as a phase shift image onto the upper surface of the load base object OB1. Then, the user or the control device 30 to be described later causes the imaging device 20 to image the load base object OB1 in a state in which the measurement image is projected.

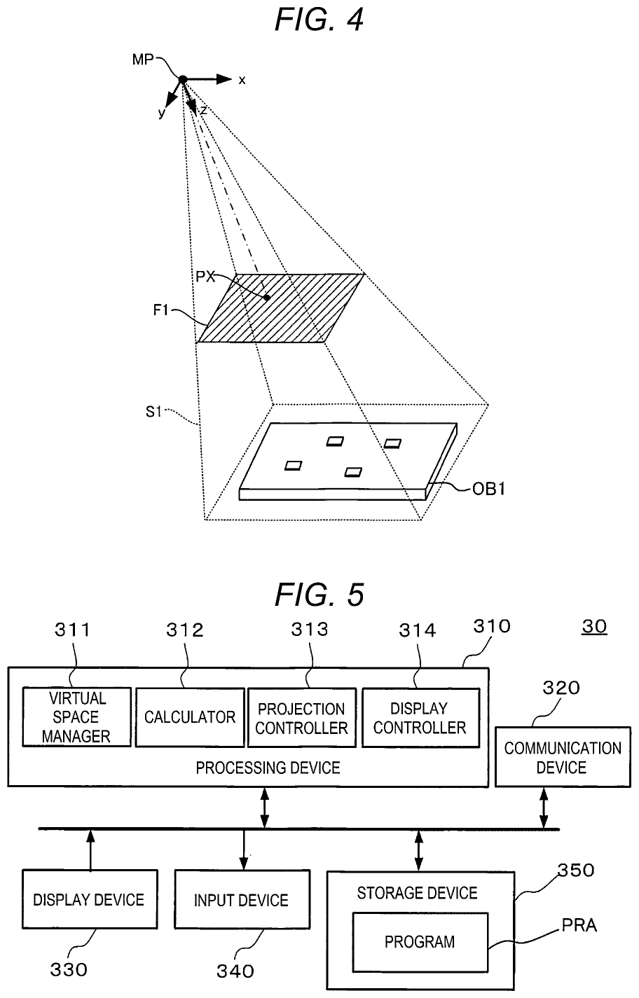

Next, the user or the control device 30 to be described later sets a plurality of measurement points on the upper surface of the load base object OB1 in the state in which the measurement image is projected, and obtains coordinates (X, Y, Z) of each measurement point in the actual space coordinate system and coordinates (mx, my) in the captured image of the imaging device 20. The coordinates (X, Y, Z) are three-dimensional coordinates, and the coordinates (mx, my) in the captured image are two-dimensional coordinates. The coordinates (mx, my) in the captured image are coordinates of pixels indicating the measurement points included in the captured image. This captured image corresponds to a front clipping plane F1 illustrated in FIG. 4. More specifically, a tip is located at the principal point MP of the imaging lens of the imaging device 20, and the front clipping plane F1 in a viewing frustum Si including the load base object OB1 is projected onto an imaging surface of the imaging device 20 via the imaging lens, thereby obtaining the captured image. The imaging surface is, for example, a surface of a CMOS sensor in which a plurality of pixels are arranged. A three-dimensional position of the measurement point in the camera coordinate system is represented as (mx, my, f) using the coordinates (mx, my) in the captured image and a distance f from the principal point MP to the front clipping plane F1.

The position (X, Y, Z) of the measurement point in the actual space coordinate system and the position (mx, my) of the measurement point in the camera coordinate system are associated with each other as illustrated in the following Formula (1) by using an internal parameter matrix F illustrated in Formula (2) and a matrix RT illustrated in Formula (3). s on the left side of Formula (1) is a scaling factor for setting the third row on the left side of Formula (1) to 1. fₓ in the internal parameter matrix F represents a focal length in the horizontal scanning direction in a focal length in the imaging lens of the imaging device 20, and f_{y} represents a focal length in the vertical scanning direction in the focal length in the imaging lens. cₓ and c_{y} are an x coordinate and a y coordinate on the captured image of an intersection point PX between the front clipping plane F1 and a straight line passing through the principal point MP and extending along the z axis.

$$S [ \begin{matrix}mx \\ my \\ 1\end{matrix} ] = F \times R T [ \begin{matrix}X \\ Y \\ Z \\ 1\end{matrix} ] \qquad ( 1 )$$

$$F = [ \begin{matrix}{f}_{x} & 0 & {c}_{x} \\ 0 & {f}_{y} & {c}_{y} \\ 0 & 0 & 1\end{matrix} ] \qquad ( 2 )$$

$$R T = [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] \qquad ( 3 )$$

The matrix RT includes a 3-row, 3-column rotation matrix including components r₁₁ to r₃₃ and a 3-row, 1-column parallel translation matrix including components ti to t₃. In the embodiment, the rotation matrix and the parallel translation matrix are the external parameters for associating the camera coordinate system with the actual space coordinate system. The rotation matrix indicates the inclination, that is, the posture of the load base object OB1 with respect to the imaging device 20. The parallel translation matrix indicates a position of the load base object OB1 with respect to the imaging device 20. For example, the user or the control device 30 to be described later can calculate the matrix RT by solving simultaneous equations obtained by substituting the coordinates in the camera coordinate system and the coordinates in the actual space coordinate system for six measurement points into Formula (1). Similarly, the user or the control device 30 to be described later can calculate the external parameters for associating the projector coordinate system with the actual space coordinate system by using the position (X, Y, Z) of the measurement point and the position (mx, my) of the measurement point in the projector coordinate system. In this case, the position (mx, my) is a position on the display panel of the projector 10 corresponding to the measurement point. The position (mx, my) of the measurement point in the projector coordinate system is the coordinates of the pixel of the display panel.

The user or the control device 30 to be described later may use the position (X, Y, Z) of the measurement point, the external parameters for associating the camera coordinate system with the actual space coordinate system, and external parameters for associating the camera coordinate system with the projector coordinate system to calculate the external parameters for associating the projector coordinate system and the actual space coordinate system. That is, the user or the control device 30 to be described later may convert the coordinates (mx, my) in the camera coordinate system into the coordinates (mx, my) in the projector coordinate system based on a correspondence relationship for associating the camera coordinate system with the projector coordinate system to calculate the position (mx, my) of the measurement point in the projector coordinate system. The correspondence relationship for associating the camera coordinate system with the projector coordinate system is a matrix for associating the pixels of the captured image with the pixels of the display panel.

The control device 30 is a device that controls the projection of the guide image G1 by the projector 10. The control device 30 is, for example, a personal computer. FIG. 5 is a diagram illustrating a configuration example of the control device 30. As illustrated in FIG. 5, the control device 30 includes a processing device 310, a communication device 320, a display device 330, an input device 340, and a storage device 350. The processing device 310 is one or more processors. The processing device 310 is, for example, a central processing unit (CPU). The processing device 310 operates according to a program PRA stored in the storage device 350 and functions as a control center of the control device 30.

The communication device 320 is a device that performs wireless communication or wired communication with other devices and includes, for example, an interface circuit. Specific examples of other devices communicating with the communication device 320 include the projector 10 and the imaging device 20.

The display device 330 includes, for example, a panel display such as a liquid crystal display, a plasma display, or an organic EL display, and a drive circuit thereof. The display device 330 displays an image of a virtual space under the control of the processing device 310. The input device 340 includes a pointing device such as a mouse and a keyboard including a plurality of operators such as a ten key. The input device 340 receives an operation of the user to the pointing device or the keyboard and outputs operation content data indicating the received operation to the processing device 310. Accordingly, the operation of the user to the input device 340 is transmitted to the processing device 310.

The storage device 350 is a recording medium readable by the processing device 310. The storage device 350 includes, for example, a non-volatile memory and a volatile memory. The non-volatile memory is, for example, a read only memory (ROM), an erasable programmable read only memory (EPROM), or an electrically erasable programmable read only memory (EEPROM). The volatile memory is, for example, a random access memory (RAM). In addition to the internal parameters and the external parameters described above, first object data, second object data, and the image data representing the guide image G1 are stored in the non-volatile memory of the storage device 350. Hereinafter, the image data representing the guide image G1 is referred to as guide image data.

The first object data is data representing a shape and a size of the load base object OB1. The second object data is data representing a shape and a size of the load OB2 and also indicating relative positions of the AR markers AM1 to AM4 viewed from the center of the upper surface of the load OB2. When the positions of the AR markers AM1 to AM4 in the actual space coordinate system are known, the position and the posture of the load OB2 in the actual space coordinate system are known based on the second object data.

Various programs are stored in the non-volatile memory. Examples of the various programs stored in the non-volatile memory include a kernel program and the program PRA. In FIG. 5, illustration of the kernel program is omitted. The kernel program is a program for causing the processing device 310 to implement an operating system (OS). When the control device 30 is powered on, the processing device 310 reads the kernel program from the non-volatile memory to the volatile memory and starts executing the read kernel program. When being instructed to start executing another program by an operation to the input device 340, the processing device 310 which operates according to the kernel program starts executing another program.

For example, when being instructed to start executing the program PRA by the operation to the input device 340, the processing device 310 reads the program PRA from the non-volatile memory to the volatile memory and starts executing the program PRA read into the volatile memory. The processing device 310, which operates according to the program PRA, functions as a virtual space manager 311, a calculator 312, a projection controller 313, and a display controller 314 illustrated in FIG. 5. That is, each of the virtual space manager 311, the calculator 312, the projection controller 313, and the display controller 314 illustrated in FIG. 5 is a software module implemented by operating the processing device 310 according to the program PRA. Roles of the virtual space manager 311, the calculator 312, the projection controller 313, and the display controller 314 illustrated in FIG. 5 are as follows.

The virtual space manager 311 places a first virtual object corresponding to the load base object OB1 and a virtual projection device corresponding to the projector 10 in a three-dimensional virtual space while maintaining a relative position relationship therebetween in the actual space. Specific examples of the three-dimensional virtual space include a computer-aided design (CAD) space. In the embodiment, the virtual space manager 311 places the first virtual object, the virtual projection device, and the virtual imaging device in the virtual space based on the external parameters described above such that a relative position relationship (positions and postures) between the first virtual object, the virtual projection device, and the virtual imaging device in the virtual space is equal to a relative position relationship between the load base object OB1, the projector 10, and the imaging device 20 in the actual space.

Hereinafter, a three-dimensional coordinate system with a center of the first virtual object as an origin, a vertical direction as a z axis, a long side direction of an upper surface of the first virtual object as an x axis, and a short side direction of the upper surface of the first virtual object as a y axis is referred to as a virtual space coordinate system. The virtual space coordinate system is an example of a three-dimensional coordinate system associated with the first virtual object. A three-dimensional coordinate system with a principal point of a projection lens of the virtual projection device as an origin, an optical axis of the virtual projection device as a z axis, a horizontal scanning direction in a projection image of the virtual projection device as an x axis, and a vertical scanning direction of the same as a y axis is referred to as a virtual projector coordinate system. A three-dimensional coordinate system with a principal point of a projection lens of the virtual imaging device as an origin, an optical axis of the virtual imaging device as a z axis, a horizontal scanning direction in a captured image of the virtual imaging device as an x axis, and a vertical scanning direction of the same as a y axis is referred to as a virtual camera coordinate system. Since the relative position relationship between the first virtual object, the virtual projection device, and the virtual imaging device in the virtual space is equal to the relative position relationship between the load base object OB1, the projector 10, and the imaging device 20 in the actual space, a relative position relationship between the virtual space coordinate system, the virtual projector coordinate system, and the virtual camera coordinate system is equal to a relative position relationship between the actual space coordinate system, the projector coordinate system, and the camera coordinate system. Therefore, the virtual space coordinate system, the virtual projector coordinate system, and the virtual camera coordinate system are associated with one another using the external parameters described above.

When the worker introduces the load OB2 into the imaging field of view of the imaging device 20 to load the load OB2 on the load base object OB1, the virtual space manager 311 places a second virtual object corresponding to the load OB2 in the virtual space. More specifically, when all of the AR markers AM1 to AM4 disposed on the upper surface of the load OB2 are recognized by analyzing the captured image of the imaging device 20, the virtual space manager 311 estimates a relative position and a relative posture of the load OB2 with respect to the imaging device 20 based on the principle of PnP described above.

As described above, in the embodiment, since the internal parameter matrix F and the matrix RT are known at the start of the assembly step, the coordinates (mx, my) in the camera coordinate system are substituted into Formula (1) for each of the AR markers AM1 to AM4 to obtain the coordinates (X, Y, Z) in the actual space coordinate system. The virtual space manager 311 estimates the relative position and the relative posture of the load OB2 with respect to the imaging device 20 based on the second object data and the coordinates in the actual space coordinate system obtained for each of the AR markers AM1 to AM4, and places the second virtual object in the virtual space based on an estimation result such that a relative position relationship between the second virtual object and the virtual imaging device in the virtual space is equal to a relative position relationship between the load OB2 and the imaging device 20 in the actual space.

As described above, in a step of loading the load OB2 on the load base object OB1, since the position and the posture of the load OB2 in the actual space change every moment, the relative position relationship between the imaging device 20 and the load OB2 introduced into the field of view of the imaging device 20 also changes every moment. According to the embodiment, even when the relative position relationship between the load OB2 and the imaging device 20 changes, the relative position relationship between the load OB2 and the imaging device 20 can be estimated at any time based on the AR markers AM1 to AM4, and a position and a posture of the second virtual object in the virtual space can follow the position and the posture of the load OB2 in the actual space.

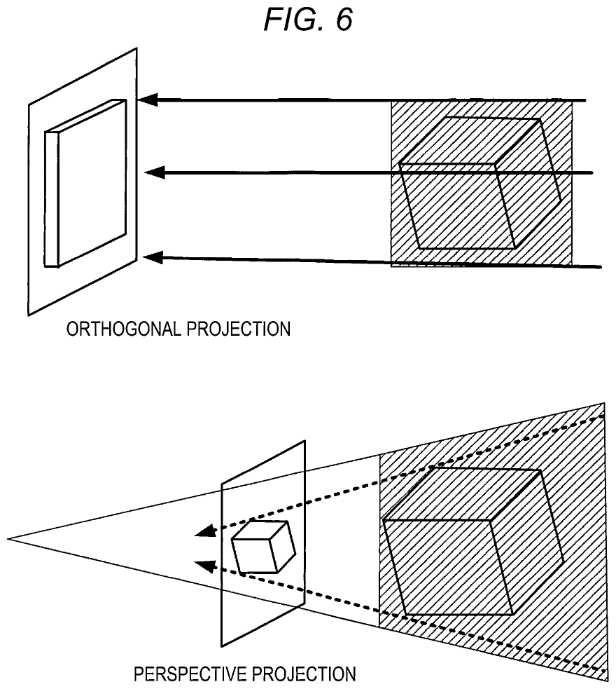

The calculator 312 sets an axis passing through the center of the first virtual object in the virtual space coordinate system and extending along the z axis in the virtual space coordinate system as a guide axis when the guide image G1 is projected onto a projection target object by an orthogonal projection. The z axis in the virtual space coordinate system is an example of an axis in a direction along the z axis in the actual space, that is, the first direction. FIG. 6 is a diagram illustrating the orthogonal projection and a perspective projection. As illustrated in FIG. 6, in the orthogonal projection, a three-dimensional object is projected in parallel to a projection plane, whereas in the perspective projection, the three-dimensional object is projected to converge to one point. The projection target object is the first virtual object before the entire load OB2 is introduced into the imaging field of view of the imaging device 20 and is the second virtual object after the entire load OB2 is introduced into the imaging field of view of the imaging device 20. This is because all of the AR markers AM1 to AM4 cannot be recognized unless at least the entire load OB2 is introduced into the imaging field of view of the imaging device 20.

The calculator 312 calculates, based on the relative position relationship between the projection target object and the virtual projection device, image data representing an orthogonal projection guide image corresponding to the guide image G1 projected from the virtual projection device to the projection target object by orthogonal projection along the guide axis. For example, when rendering information for coloring or the like is given to the projection target object (the first virtual object or the second virtual object in the embodiment), the calculator 312 updates the rendering information based on the guide image data, thereby projecting and mapping the guide image G1 onto a surface of the projection target object by the orthogonal projection. Then, the calculator 312 generates the image data representing the orthogonal projection guide image based on an image of the projection target object having a surface onto which the guide image G1 is projected and mapped, which is obtained by viewing through the viewing frustum of the virtual projection device. As described above, even when the position and the posture of the load OB2 in the actual space change, the position and the posture of the second virtual object in the virtual space can follow the position and the posture of the load OB2 in the actual space. Therefore, when the second virtual object is the projection target object, even when the position and the posture of the load OB2 change, the orthogonal projection guide image following the change can be generated.

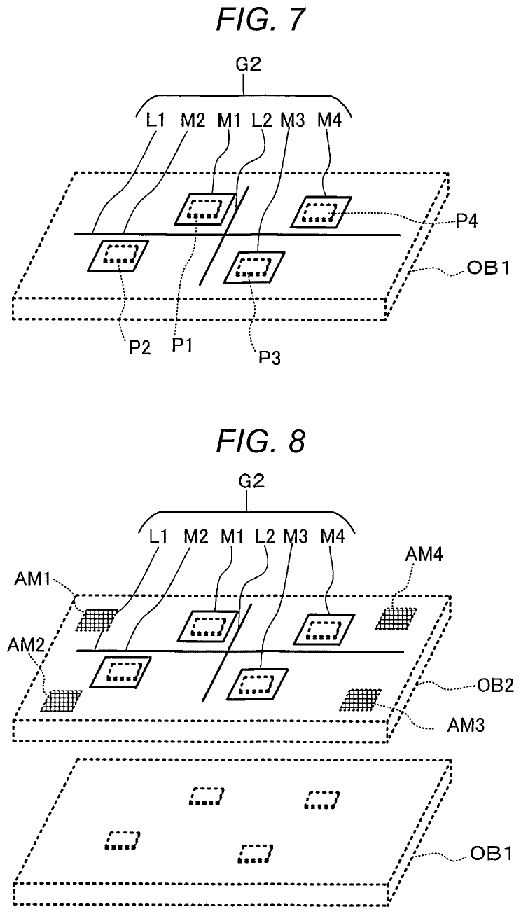

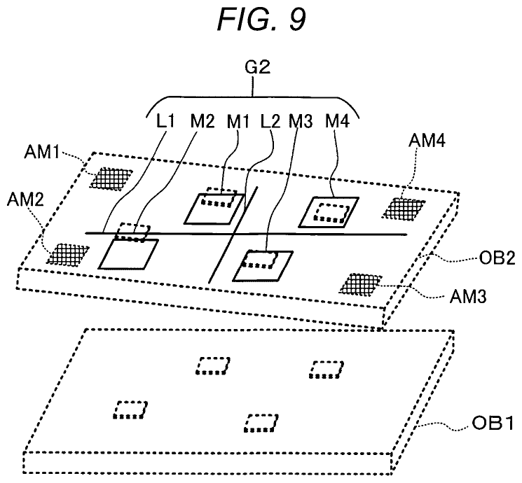

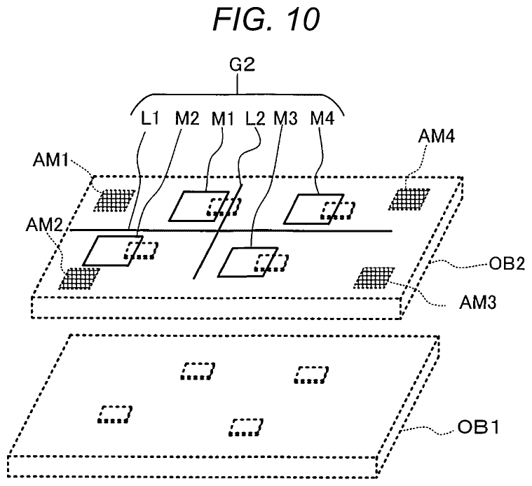

The projection controller 313 controls the projector 10 to project the guide image G1 onto the projection target object by the orthogonal projection. The projection controller 313 transmits the image data representing the orthogonal projection guide image to the projector 10 and causes the projector 10 to project the guide image onto the projection target object by the orthogonal projection. For example, before the load OB2 is introduced into the imaging field of view of the imaging device 20, since the image data of the orthogonal projection guide image corresponding to the guide image G1 projected onto the first virtual object by the orthogonal projection along the guide axis is generated by the calculator 312, an orthogonal projection guide image G2 is projected from the projector 10 onto the load base object OB1 as illustrated in FIG. 7. In contrast, after the entire load OB2 is introduced into the imaging field of view of the imaging device 20, since the image data of the orthogonal projection guide image corresponding to the guide image G1 projected onto the second virtual object by the orthogonal projection along the guide axis is generated by the calculator 312, the orthogonal projection guide image G2 is projected from the projector 10 onto the load OB2 as illustrated in FIG. 8. Since the orthogonal projection guide image G2 is displayed on the upper surface of the load OB2, the worker can position the load OB2 without looking at the space between the load OB2 and the load base object OB1 such that the four protrusions on the upper surface of the load OB2 fall inside the markers M1 to M4, respectively. Since the orthogonal projection guide image G2 is displayed on the upper surface of the load OB2, as illustrated in FIG. 9, when the load OB2 is inclined with respect to the load base object OB1, or even when the load OB2 is shifted to at least one side in the long side direction or the short side direction of the upper surface of the load base object OB1 with respect to the load base object OB1 as illustrated in FIG. 10, the load OB2 can be positioned such that the four protrusions on the upper surface of the load OB2 fall inside the markers M1 to M4. FIG. 10 illustrates a state in which the load OB2 is shifted in the long side direction of the upper surface of the load base object OB1 with respect to the load base object OB1.

The display controller 314 displays a virtual video, which is a video of the virtual space in which the first virtual object, the second virtual object, the virtual projection device, and the virtual detection device are disposed, on the display device 330. By displaying the virtual video on the display device 330, the user of the positioning system 1 can check a state of the operation of loading the load OB2 on the load base object OB1 by checking the virtual video displayed on the display device 330. Examples of the user of the positioning system 1 include an operation supervisor who gives various instructions to a worker who executes the operation of loading the load OB2 on the load base object OB1. Blind spots are always generated when the state of the operation described above is captured by the imaging device 20, whereas with the virtual video, there are no blind spots, making it easier to check that the positioning is correctly performed. The display controller 314 may display the virtual video and an actual video captured by the imaging device 20 side by side on the display device 330. According to this aspect, the user can check the state of the operation by comparing the virtual video with the actual video, making it easier to check whether the positioning is correctly performed.

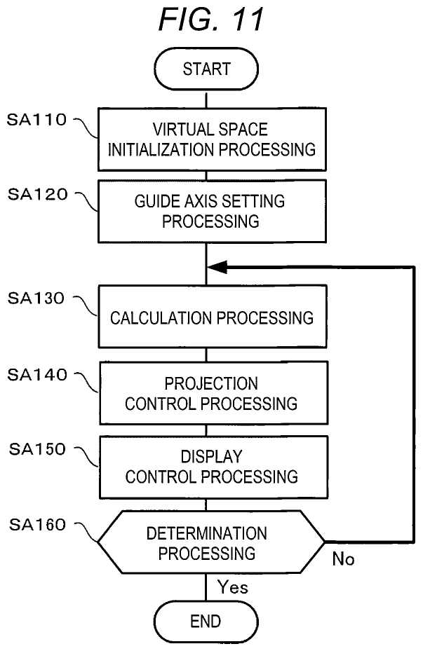

The processing device 310 which operates according to the program PRA executes a positioning method that prominently expresses characteristics of the present disclosure. At a start of this positioning method, the external parameters described above are already calculated. FIG. 11 is a flowchart illustrating a flow of this positioning method. As illustrated in FIG. 11, this positioning method includes processing of a virtual space initialization processing SA110, a guide axis setting processing SA120, a calculation processing SA130, a projection control processing SA140, a display control processing SA150, and a determination processing SA160. Processing contents of the virtual space initialization processing SA110, the guide axis setting processing SA120, the calculation processing SA130, the projection control processing SA140, the display control processing SA150, and the determination processing SA160 are as follows.

In the virtual space initialization processing SA110, the processing device 310 functions as the virtual space manager 311. In the virtual space initialization processing SA110, the processing device 310 places, based on the external parameters described above, the first virtual object corresponding to the load base object OB1, the virtual projection device corresponding to the projector 10, and the virtual detection device corresponding to the imaging device 20 in the virtual space while maintaining the relative position relationship between the projector 10, the imaging device 20, and the load base object OB1 in the actual space. The positioning method of the present disclosure may include processing of estimating the external parameters using the principle of PnP described above, which is processing executed before the virtual space initialization processing SA110.

In the guide axis setting processing SA120, the processing device 310 functions as the calculator 312. In the guide axis setting processing SA120, the processing device 310 sets the axis passing through the center of the first virtual object in the virtual space coordinate system and extending along the z axis in the virtual space coordinate system as the guide axis when the guide image G1 is projected onto the projection target object by the orthogonal projection.

In the calculation processing SA130, the processing device 310 functions as the virtual space manager 311 and the calculator 312. In the calculation processing SA130, the processing device 310 first functions as the virtual space manager 311 and determines whether the entire load OB2 is introduced into the imaging field of view of the imaging device 20 based on whether the AR markers AM1 to AM4 are detected. If all of the AR markers AM1 to AM4 are detected from the captured image of the imaging device 20, the processing device 310 determines that the entire load OB2 is introduced into the imaging field of view of the imaging device 20. On the other hand, if at least one of the AR markers AM1 to AM4 is not detected from the captured image of the imaging device 20, the processing device 310 determines that the entire load OB2 is not introduced into the imaging field of view of the imaging device 20.

When it is determined that the entire load OB2 is not introduced into the imaging field of view of the imaging device 20, the processing device 310 functions as the calculator 312 and calculates, based on the guide image data, the image data representing the orthogonal projection guide image G2 corresponding to the guide image G1 projected from the virtual projection device to the first virtual object by the orthogonal projection along the guide axis, based on the relative position relationship between the first virtual object and the virtual projection device. When it is determined that the entire load OB2 is introduced into the imaging field of view of the imaging device 20, the processing device 310 first estimates the relative position relationship between the imaging device 20 and the load OB2 and places the second virtual object in the virtual space while maintaining the relative position relationship. Next, the processing device 310 functions as the calculator 312 and calculates, based on the guide image data, the image data representing the orthogonal projection guide image G2 corresponding to the guide image G1 projected from the virtual projection device onto the second virtual object by the orthogonal projection along the guide axis, based on the relative position relationship between the second virtual object and the virtual projection device.

In the projection control processing SA140, the processing device 310 functions as the projection controller 313. In the projection control processing SA140, the processing device 310 projects the orthogonal projection guide image G2 onto the projection target object by giving the image data generated in the calculation processing SA130 to the projector 10. In the display control processing SA150, the processing device 310 functions as the display controller 314. In the display control processing SA150, the processing device 310 displays the virtual video, which is the video of the virtual space, on the display device 330. An execution order of the projection control processing SA140 and the display control processing SA150 may be changed, and the display control processing SA150 may be executed before the projection control processing SA140.

In the determination processing SA160, the processing device 310 determines whether an end of the present positioning method is instructed by the operation to the input device 340. If the end of the present positioning method is instructed by the operation to the input device 340, a determination result of the determination processing SA160 is “Yes”. If the determination result of the determination processing SA160 is “Yes”, the processing device 310 ends the present positioning method. If the end of the present positioning method is not instructed by the operation to the input device 340, the determination result of the determination processing SA160 is “No”. If the determination result of the determination processing SA160 is “No”, the processing device 310 executes the calculation processing SA130 and the subsequent processing again.

As described above, according to the embodiment, the worker can place the load OB2 at a desired position according to the orthogonal projection guide image G2 projected onto the load OB2, without looking at the space between the load OB2 and the load base object OB1. According to the embodiment, since the orthogonal projection guide image G2, which is desired to be reflected on the load OB2, is projected from the projector 10 onto the load OB2 when the guide image G1 is projected by the orthogonal projection, it is possible to prevent a decrease in positioning accuracy even when the projector 10 is provided in a position away from vertically above the load base object OB1 in the actual space. The display controller 314 in the embodiment is not an essential component of the present disclosure and may be omitted. Similarly, the display control processing A150 can be omitted.

### 2. Other Embodiments

### (1) Second Embodiment

The calculator 312 may change a projection mode of the orthogonal projection guide image G2 according to the number of markers projected onto the positions of the corresponding reference points among the markers M1 to M4 included in the guide image G1 projected onto the second virtual object in the virtual space. For example, an aspect is described in which when all of the markers M1 to M4 are projected onto the positions of the corresponding reference points, a color of each of the markers M1 to M4 is set to green, and when at least one of the markers is not projected onto the position of the corresponding reference point, the color of each of the markers M1 to M4 is set to red. An aspect may be considered in which when the number of markers projected onto the positions of the corresponding reference points is 0, the color of each of the markers M1 to M4 is set to red, when the number of markers projected onto the positions of the corresponding reference points is 1 to 3, the color of each of the markers M1 to M4 is set to yellow, and when all the markers are projected onto the positions of the corresponding reference points, the color of each of the markers M1 to M4 is set to green. According to these aspects, it is possible to easily identify whether the position of the load OB2 matches all the reference points. An aspect may be considered in which the color of the marker projected onto the position of the corresponding reference point is set to green, and the color of the marker not projected onto the position of the corresponding reference point is set to red. According to this aspect, the worker can easily identify whether the position of the load OB2 matches each reference point. In addition, an aspect may be considered in which a shape of the marker may be changed according to the number of markers projected onto the positions of the corresponding reference points instead of the color of the marker. According to the second embodiment, it is possible to improve workability particularly, for example, when positioning the large-sized load OB2 by a plurality of persons.

### (2) Third Embodiment

When estimating the relative position and posture of the imaging device 20 and the load OB2, the virtual space manager 311 may estimate the relative position and posture of the imaging device 20 and the load OB2 by a posture estimation using artificial intelligence based on an outer shape, a feature point, or the like, of the load OB2 without using the AR markers. According to the present aspect, there is no need to attach the AR markers to the load OB2. According to the embodiment, since there is no need to attach the AR markers to the load OB2, the workability in the entire step of manufacturing a product by loading the load OB2 on the load base object OB1 can be improved as compared with the first embodiment.

### (3) Fourth Embodiment

The number of projectors 10 included in the positioning system 1 in the embodiments described above is one, and may be two or more. For example, when a projection target object is larger than a range in which an image can be projected from the projector 10, a plurality of projectors 10 may be used and different projection regions may be allocated to the respective projectors 10. Accordingly, it is possible to perform a positioning guide on a large load OB2 for which the projection cannot be performed without using the plurality of projectors. For example, the embodiment can be applied to the positioning of a subassembly part of a large product such as an aircraft or a ship. Similarly, when the entire load OB2 does not fall within an imaging field of view of the imaging device 20, a plurality of imaging devices 20 may be used.

### 3. Modifications

Each of the embodiments described above may be deformed as follows.

(1) In the embodiments described above, the position and the posture of the load base object OB1 in the actual space are fixed. However, it is not essential that the position and the posture of the load base object OB1 in the actual space are fixed. This is because, for example, it is possible to estimate the relative position and the relative posture of the load base object OB1 with respect to the imaging device 20 based on the principle of PnP described above by applying the AR marker to the load base object OB1 similarly to the load OB2.

(2) In the embodiments described above, the relative position relationship between the projector 10 and the imaging device 20 in the actual space is estimated using the principle of PnP. However, the relative position relationship between the projector 10 and the imaging device 20 may be fixed. Examples of a case in which the relative position relationship between the projector 10 and the imaging device 20 is fixed include a case in which the imaging device 20 is built into the projector 10 such as a case where the projector 10 is a projector having a built-in camera. When the relative position relationship between the projector 10 and the imaging device 20 is fixed, information indicating the position relationship is stored in the storage device 350, thereby obtaining the same effects as those of the embodiments described above.

(3) The virtual space manager 311, the calculator 312, the projection controller 313, and the display controller 314 in the embodiments described above are software modules. However, any one, any two, any three, or all of the virtual space manager 311, the calculator 312, the projection controller 313, and the display controller 314 may be a hardware module such as an application specific integrated circuit (ASIC). The same effects as those of the embodiments described above can be achieved even when any one, any two, any three, or all of the virtual space manager 311, the calculator 312, the projection controller 313, and the display controller 314 are a hardware module.

(4) The program PRA may be manufactured separately and may be provided with or without payment. Specific aspects at the time of providing the program PRA include an aspect in which the program PRA is written in a computer-readable recording medium such as a flash ROM and is provided and an aspect in which the program PRA is provided by being downloaded via an electric communication line such as the Internet. By operating a general computer according to the program PRA provided in these aspects, the computer can execute the positioning method of the present disclosure.

4. The embodiments exemplified above can be variously deformed. Specific aspects of deformations applicable to the embodiments described above will be exemplified below. Two or more aspects optionally selected from the following exemplification can be combined as appropriate in a range in which the aspects do not contradict one another.

### 4-1. Modification 1

In the embodiments described above, the load base object OB1 is a lower part of the product manufactured in the assembly step, and the load OB2 is an upper part of the product. However, the present disclosure is not limited to this aspect. For example, the load base object OB1 may be a placement table for placing the load OB2. For example, the load base object OB1 may be a platen on which a print medium, serving as the load OB2 to which an ink is applied, is placed in a digital ink jet printer. The load base object OB1 and the load OB2 may be film-shaped articles. That is, the technology according to the present disclosure can be applied to all devices in which a situation of loading the load OB2 on the load base object OB1 is generated.

### 4-2. Modification 2

In the embodiments described above, the loading direction in which the load OB2 is loaded on the load base object OB1 is the gravity direction. However, the present disclosure is not limited to this aspect. For example, the loading direction may be a horizontal direction intersecting the gravity direction.

### 5. Summary of Present Disclosure

The present disclosure is not limited to the embodiments and modifications described above and can be implemented in various aspects without departing from the spirit of the present disclosure. For example, the present disclosure can also be implemented in the following aspects. To solve some or all of the problems described in the present disclosure, or to achieve some or all of the effects of the present disclosure, technical features of the embodiments described above that correspond to the technical features in each of the following aspects can be replaced or combined as appropriate. The technical features can be deleted as appropriate unless described as essential technical features in the present specification.

A summary of the present disclosure will be given below in the form of appendices.

### APPENDIX 1

A positioning method of the present disclosure is a positioning method, which is method for positioning a second object to be loaded on a first object in a first direction of an actual space, and the positioning method includes: placing, in a virtual space, a first virtual object corresponding to the first object, a virtual projection device corresponding to a projection device configured to project a guide image, for showing a loading position of the second object with respect to the first object, onto at least one of the first object and the second object, and a virtual detection device corresponding to a detection device configured to detect at least the second object in the actual space, while maintaining a relative position relationship therebetween in the actual space, and placing a second virtual object corresponding to the second object in the virtual space according to a detection result by the detection device; setting an axis parallel to the first direction as a guide axis when orthogonally projecting the guide image, among three axes constituting a three-dimensional coordinate system associated with the first virtual object; generating an orthogonal projection guide image corresponding to the guide image projected from the virtual projection device onto the second virtual object by an orthogonal projection along the guide axis, based on the relative position relationship between the virtual projection device and the second virtual object placed in the virtual space according to the detection result by the detection device; and controlling the projection device to project the orthogonal projection guide image onto the second object. According to the present aspect, since the orthogonal projection guide image, which is desired to be reflected on the second object, is projected from the projection device onto the second object when the guide image for showing the loading position of the second object with respect to the first object in the first direction is projected by the orthogonal projection, it is possible to prevent a decrease in positioning accuracy of the second object even when the projection device is provided in a position away from vertically above the first object in the actual space.

### APPENDIX 2

A more preferred aspect of the positioning method is the positioning method according to (Appendix 1), in which the guide image includes a plurality of markers respectively corresponding to a plurality of reference points on a surface of the first object on which the second object is to be loaded, and the generating the orthogonal projection guide image includes changing a projection mode of the orthogonal projection guide image according to the number of markers projected onto positions of the corresponding reference points in the guide image projected onto the second virtual object by the orthogonal projection. According to the present aspect, the worker who executes an operation of loading the second object on the first object can easily grasp that the positioning is correctly performed based on the projection mode of the guide image.

### APPENDIX 3

A more preferred aspect of the positioning method is the positioning method according to (Appendix 2), in which the changing the projection mode of the orthogonal projection guide image includes varying a color of a marker in the orthogonal projection guide image between when all the markers are projected onto the positions of the corresponding reference points and when at least one of the markers is not projected onto the position of the corresponding reference point. According to the present aspect, the worker who executes the operation of loading the second object on the first object can easily grasp that the positioning is correctly performed based on the color of the plurality of markers included in the guide image.

### APPENDIX 4

Another preferred aspect of the positioning method is the positioning method according to any one of (Appendix 1) to (Appendix 3), in which a virtual video that is a video of the virtual space in which the first virtual object, the second virtual object, the virtual projection device, and the virtual detection device are placed is displayed on a display device. Since the virtual video has no blind spots, whether the positioning is performed correctly can be checked smoothly according to the present aspect.

### APPENDIX 5

Another preferred aspect of the positioning method is the positioning method according to (Appendix 4), in which the detection device is an imaging device configured to image the first object and the second object, and the virtual video and an actual video captured by the imaging device are displayed on the display device. According to the present aspect, the state of the operation can be checked by comparing the virtual video with the actual video, making it easier to check whether the positioning is correctly performed.

### APPENDIX 6

A positioning system of the present disclosure is a positioning system for positioning a second object to be loaded on a first object in a first direction of an actual space, and the positioning system includes: a projection device configured to project a guide image for showing a loading position of the second object with respect to the first object onto at least one of the first object and the second object; a detection device configured to detect at least the second object in the actual space; and a processing device, in which the processing device places, in a virtual space, a first virtual object corresponding to the first object, a virtual projection device corresponding to the projection device, and a virtual detection device corresponding to the detection device while maintaining a relative position relationship therebetween in the actual space, and places a second virtual object corresponding to the second object in the virtual space according to a detection result by the detection device; sets an axis parallel to the first direction as a guide axis when orthogonally projecting the guide image, among three axes constituting a three-dimensional coordinate system associated with the first virtual object; generates an orthogonal projection guide image corresponding to the guide image projected from the virtual projection device onto the second virtual object by an orthogonal projection along the guide axis, based on a relative position relationship between the second virtual object placed in the virtual space according to the detection result by the detection device, the virtual detection device, and the virtual projection device; and controls the projection device to project the orthogonal projection guide image onto the second object. According to the present aspect, similarly to the positioning method according to (Appendix 1), it is possible to prevent a decrease in positioning accuracy of the second object even when the projection device is provided in a position away from vertically above the first object in the actual space.

What is claimed is:

1. A positioning method for positioning a second object to be loaded on a first object in a first direction of an actual space, the positioning method comprising:
placing, in a virtual space, a first virtual object corresponding to the first object, a virtual projection device corresponding to a projection device configured to project a guide image for showing a loading position of the second object with respect to the first object onto at least one of the first object and the second object, and a virtual detection device corresponding to a detection device configured to detect at least the second object in the actual space, while maintaining a relative position relationship therebetween in the actual space, and placing a second virtual object corresponding to the second object in the virtual space according to a detection result by the detection device;
setting an axis parallel to the first direction as a guide axis when orthogonally projecting the guide image, among three axes constituting a three-dimensional coordinate system associated with the first virtual object;
generating an orthogonal projection guide image corresponding to the guide image projected from the virtual projection device onto the second virtual object by an orthogonal projection along the guide axis, based on the relative position relationship between the virtual projection device and the second virtual object placed in the virtual space according to the detection result by the detection device; and
controlling the projection device to project the orthogonal projection guide image onto the second object.

2. The positioning method according to claim 1, wherein
the guide image includes a plurality of markers respectively corresponding to a plurality of reference points on a surface of the first object on which the second object is to be loaded, and
the generating the orthogonal projection guide image includes changing a projection mode of the orthogonal projection guide image according to a number of the markers projected onto positions of corresponding ones of the reference points in the guide image projected onto the second virtual object by the orthogonal projection.

3. The positioning method according to claim 2, wherein
the changing the projection mode of the orthogonal projection guide image includes varying a color of the marker in the orthogonal projection guide image between when all the markers are projected onto the positions of the corresponding ones of the reference points and when at least one of the markers is not projected onto the position of corresponding one of the reference points.

4. The positioning method according to claim 1, further comprising:
displaying, on a display device, a virtual video that is a video of the virtual space in which the first virtual object, the second virtual object, the virtual projection device, and the virtual detection device are placed.

5. The positioning method according to claim 4, wherein
the detection device is an imaging device configured to image the first object and the second object, and
the virtual video and an actual video captured by the imaging device are displayed on the display device.

6. A positioning system for positioning a second object to be loaded on a first object in a first direction of an actual space, the positioning system comprising:
a projection device configured to project a guide image for showing a loading position of the second object with respect to the first object onto at least one of the first object and the second object;
a detection device configured to detect at least the second object in the actual space; and
one or more processors configured to:
place, in a virtual space, a first virtual object corresponding to the first object, a virtual projection device corresponding to the projection device, and a virtual detection device corresponding to the detection device while maintaining a relative position relationship therebetween in the actual space, and place a second virtual object corresponding to the second object in the virtual space according to a detection result by the detection device,
set an axis parallel to the first direction as a guide axis when orthogonally projecting the guide image, among three axes constituting a three-dimensional coordinate system associated with the first virtual object,
generate an orthogonal projection guide image corresponding to the guide image projected from the virtual projection device onto the second virtual object by an orthogonal projection along the guide axis, based on a relative position relationship between the second virtual object placed in the virtual space according to the detection result by the detection device, the virtual detection device, and the virtual projection device, and
control the projection device to project the orthogonal projection guide image onto the second object.
